(19) United States
(12) Patent Application Publication
(10) Pub. No.: US 2026/0058319 A1
(43) Pub. Date: Feb. 26, 2026

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); AESC JAPAN LTD., Kanagawa (JP)

(72) Inventors: Kotaro TAKADA, Osaka (JP); Osamu NAKAYAMA, Osaka (JP); Shuya IKEDA, Osaka (JP); Katsushi MIYAZAKI, Osaka (JP); Takami IZAWA, Kanagawa (JP); Masayuki NAKAI, Kanagawa (JP); Yasuhiro YANAGIHARA, Kanagawa (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP); AESC JAPAN LTD., Kanagawa (JP)

(21) Appl. No.: 19/117,689

(22) PCT Filed: Oct. 4, 2023
(86) PCT No.: PCT/JP2023/036203

§ 371 Date: Apr. 2, 2025

(30) Foreign Application Priority Data
Oct. 6, 2022 (JP) 2022-161666

(51) Int. Cl. H01M 50/503; H01M 50/209; H01M 50/298

(52) U.S. Cl. CPC H01M 50/503; H01M 50/209; H01M 50/298

(57) ABSTRACT

A wiring module is to be coupled to a battery stack member that includes laminated type batteries having electrode leads being stacked and the electrode leads of the laminated type batteries are overlapped and connected and configured as connection portions. The wiring module is to be coupled to the battery stack member including the connection portions in a coupling direction that is perpendicular to a plate thickness direction of the connection portions. The wiring module includes terminals, electric wires connected to the terminals, and a protector holding the terminals and the electric wires. The electrode leads include connection electrode leads that are configured as the connection portions. The terminals include electrode connection portions that are electrically connected to the connection electrode leads. The protector includes a protector body and terminal housing portions in which the terminals are disposed with being positioned.

### TECHNICAL FIELD

The present disclosure relates to a wiring module.

### BACKGROUND ART

A high-pressure battery pack that is used in an electric automobile or a hybrid automobile normally includes battery cells that are disposed on top of each other and are electrically connected in series or in parallel to each other with a wiring module. A battery module that is disclosed in Japanese Translation of PCT International Application Publication No. 2020-527848 (Patent Document 1 described below) has been known as an example of such a wiring module. The battery module described in Patent Document 1 includes a cell assembly, a module housing, and end frames. The cell assembly includes battery cells that have electrode leads at front and rear end portions thereof and are stacked in a right-left direction. The module housing has four side walls including upper and lower side walls and right and left side walls. The module housing has an inner space defined by the four side walls and the cell assembly is disposed in the inner space. The end frames are attached to front and rear ends of the cell assembly and the cell assembly and an external device are electrically connected via the end frames.

### PRIOR ART

### Patent Document

Patent Document 1: Japanese Translation of PCT International Application Publication No. 2020-527848

### SUMMARY OF THE INVENTION

### Problem to be Solved by the Invention

In the configuration described above, the electrode leads of the adjacent battery cells are bent to be closer to each other and overlapped so as to be electrically connected. In such a configuration, busbars for connecting the electrode leads are not necessary. The electrode leads are electrically connected to module terminals on the end frames. However, manufacturing tolerances are likely to be caused in the connected portions of the electrode leads particularly in the front-rear direction due to the bending of the electrode leads and welding of the electrode leads. Therefore, in attaching the end frames to the cell assembly, the electrode lead and the module terminal may be welded without being contacted to each other effectively and an electrical connection error may occur.

### Means for Solving the Problem

A wiring module according to the present disclosure is to be coupled to a battery stack member that includes laminated type batteries having electrode leads being stacked and the electrode leads of the laminated type batteries are overlapped and connected and configured as connection portions. The wiring module is to be coupled to the battery stack member that includes the connection portions in a coupling direction that is perpendicular to a plate thickness direction of the connection portions. The wiring module includes terminals, electric wires connected to the terminals, and a protector holding the terminals and the electric wires. The electrode leads include connection electrode leads that are configured as the connection portions, the terminals include electrode connection portions that are electrically connected to the connection electrode leads, the protector includes a protector body and terminal housing portions in which the terminals are disposed with being positioned, and each of the terminal housing portions is connected movably to the protector body via a hinge portion.

### Effects of the Invention

According to the present disclosure, a wiring module that can suppress contact failure of an electrode lead and a terminal can be provided.

### BRIEF DESCRIPTION OF THE DRAWINGS

FIG. 1 is a perspective view of a battery module according to a first embodiment.

FIG. 2 is a front view of the battery module.

FIG. 3 is an enlarged front view of a portion of the battery module including a terminal housing portion.

FIG. 4 is a rear view of the battery module.

FIG. 5 is an enlarged perspective view of a portion of the battery module including the terminal housing portion.

FIG. 6 is an enlarged perspective view of a protector near the terminal housing portion.

FIG. 7 is a perspective view of a terminal.

FIG. 8 is a perspective view of a battery stack member.

FIG. 9 is a view illustrating the wiring module that is being coupled to the battery stack member in a coupling direction.

FIG. 10 is a cross-sectional view along A-A line in FIG. 2.

FIG. 11 is a view illustrating a hinge portion that is not deformed with a cross section along B-B line in FIG. 3.

FIG. 12 is a view illustrating an end portion of a connection electrode lead that is contacted with a slope surface with the cross section along B-B line in FIG. 3.

FIG. 13 is a view illustrating the connection electrode lead and an electrode connection portion that are connected with the terminal housing portion being moved forward by deformation of the hinge portion with the cross section along B-B line in FIG. 3.

FIG. 14 is a view illustrating the connection electrode lead and an electrode connection portion that are connected with the terminal housing portion being moved rearward by deformation of the hinge portion with the cross section along B-B line in FIG. 3.

FIG. 15 is a cross-sectional view along C-C line in FIG. 3.

FIG. 16 is a cross-sectional view along D-D line in FIG. 3.

FIG. 17 is a view illustrating the connection electrode lead that is inclined rearward as it extends leftward with the cross section along D-D line in FIG. 3.

FIG. 18 is a view illustrating the connection electrode lead including a warped portion with a cross section along E-E line in FIG. 3.

FIG. 19 is a cross-sectional view along F-F line in FIG. 12.

FIG. 20 is an enlarged front view of a portion of a battery module including a terminal housing portion according to a second embodiment.

FIG. 21 is a cross-sectional view along G-G line in FIG. 20.

FIG. 22 is a view illustrating the terminal housing portion that is rotated with a cross section along G-G line in FIG. 20.

### MODES FOR CARRYING OUT THE INVENTION

### Description of Embodiments According to the Present Disclosure

First, embodiments according to the present disclosure will be listed and described.

(1) A wiring module according to the present disclosure is to be coupled to a battery stack member that includes laminated type batteries having electrode leads being stacked and the electrode leads of the laminated type batteries are overlapped and connected and configured as connection portions. The wiring module is to be coupled to the battery stack member that includes the connection portions in a coupling direction that is perpendicular to a plate thickness direction of the connection portions. The wiring module includes terminals, electric wires connected to the terminals, and a protector holding the terminals and the electric wires. The electrode leads include connection electrode leads that are configured as the connection portions, the terminals include electrode connection portions that are electrically connected to the connection electrode leads, the protector includes a protector body and terminal housing portions in which the terminals are disposed with being positioned, and each of the terminal housing portions is connected movably to the protector body via a hinge portion.

According to such a configuration, when the wiring module is coupled to the battery stack member, the electrode connection portion is likely to move along the connection electrode lead. Therefore, the electrical connection error is less likely to occur between the connection electrode lead and the terminal.

(2) The hinge portion preferably includes reduced thickness portions.

According to such a configuration, the hinge portion is deformed easily and the terminal housing portion can move easily with respect to the protector body.

(3) The hinge portion preferably includes hinge portions and the hinge portions are preferably provided for each of the terminal housing portions.

According to such a configuration, the movement of the terminal housing portion with respect to the protector body can be controlled easily.

(4) The terminals preferably include slope surfaces that are continuous to the electrode connection portions and inclined toward one side with respect to the plate thickness direction as the slope surfaces extend toward a back side with respect to the coupling direction, and each of the slope surfaces is preferably disposed in at least a section of a range in which corresponding one of the connection electrode leads is to be disposed with respect to the plate thickness direction.

According to such a configuration, when the wiring module is coupled to the battery stack member, with the slope surface sliding along the end portion of the connection electrode lead on the front side with respect to the coupling direction, the terminal moves in the plate thickness direction with respect to the connection electrode lead. Therefore, the electrode connection portion easily moves along the connection electrode lead.

(5) The terminal housing portions preferably include electrode support portions that are disposed opposite the electrode connection portions with respect to the plate thickness direction, the slope surfaces are preferably inclined so as to be away from the electrode support portions as the slope surfaces extend toward the back side with respect to the coupling direction, and the connection electrode leads are preferably disposed between the electrode connection portions and the electrode support portions, respectively, with respect to the plate thickness direction.

According to such a configuration, when the wiring module is coupled to the battery stack member, the connection electrode lead is disposed between the electrode connection and the electrode support portion and therefore, the electrode connection portion easily moves along the connection electrode lead.

(6) The electrode support portions preferably include electrode support portion side slope surfaces at end portions on the back side with respect to the coupling direction and the electrode support portion side slope surfaces are preferably inclined toward another side with respect to the plate thickness direction as the electrode support portion side slope surfaces extend toward the back side with respect to the coupling direction, and each of the electrode support portion side slope surfaces is preferably disposed in at least a section of the range in which corresponding one of the connection electrode leads is to be disposed with respect to the plate thickness direction.

According to such a configuration, when the wiring module is coupled to the battery stack member, with the electrode support portion side slope surface sliding along the end portion of the connection electrode lead on the front side with respect to the coupling direction, the terminal housing portion moves in the plate thickness direction with respect to the connection electrode lead. Therefore, the connection electrode lead is easily disposed between the electrode connection portion and the electrode support portion.

(7) A direction perpendicular to the plate thickness direction and the coupling direction is preferably defined as a terminal width direction. Each of the terminal housing portions preferably includes a pair of terminal protection arms on two side portions of each of the electrode connection portions and the pair of terminal protection arms extend toward the back side with respect to the coupling direction further than the slope surfaces, and the pair of terminal protection arms are preferably on the one side with respect to the connection electrode leads in the plate thickness direction.

According to such a configuration, the terminal is protected by the terminal protection arms.

(8) The terminal protection arms preferably include terminal protection arm side slope surfaces on end portions on the back side with respect to the coupling direction and the terminal protection arm side slope surfaces are preferably inclined toward the one side with respect to the plate thickness direction as the terminal protection arm side slope surfaces extend toward the back side with respect to the coupling direction, and each of the terminal protection arm side slope surfaces is preferably disposed in at least a section of the range in which corresponding one of the connection electrode leads is to be disposed with respect to the plate thickness direction.

According to such a configuration, when the wiring module is coupled to the battery stack member, with the electrode support portion side slope surface sliding along the end portion of the connection electrode lead on the front side with respect to the coupling direction, the terminal housing portion moves in the plate thickness direction with respect to the connection electrode lead. Therefore, the connection electrode lead is easily disposed between the electrode connection portion and the electrode support portion.

### Details of Embodiments According to the Present Disclosure

Embodiments according to the present disclosure will be described. The present disclosure is not limited to the embodiments. All modifications within and equivalent to the technical scope of the claimed invention may be included in the technical scope of the present invention.

### First Embodiment

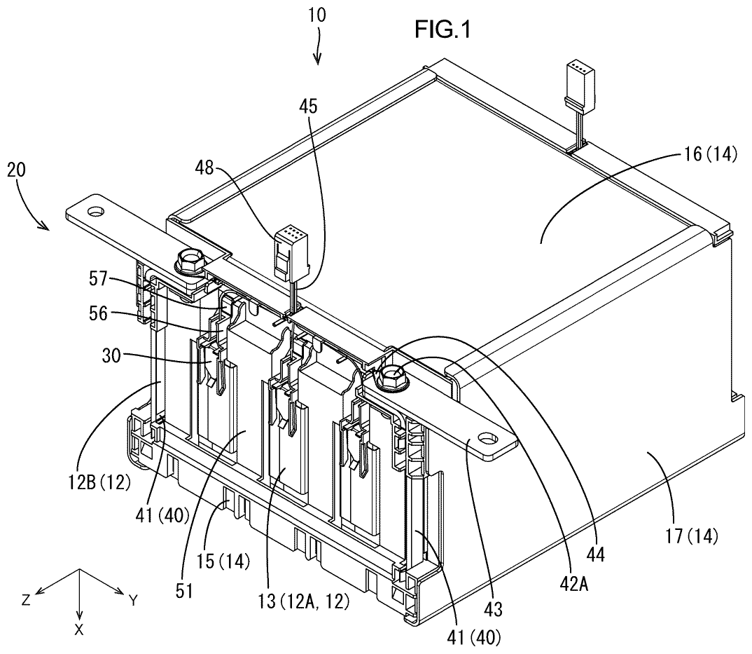

A first embodiment of the present disclosure will be described with reference to FIGS. 1 to 19. A battery module 10 including a wiring module 20 according to this embodiment is installed in a vehicle as a power source for driving a vehicle such as an electric automobile or a hybrid automobile. In the following description, regarding components having the same configuration, some of the components may be indicated by reference signs and others may not be indicated by the reference signs. In the following description, it is considered that an X arrow, a Y arrow, and an Z arrow point the lower side, the left side, and the front side, respectively.

### Battery Stack Member

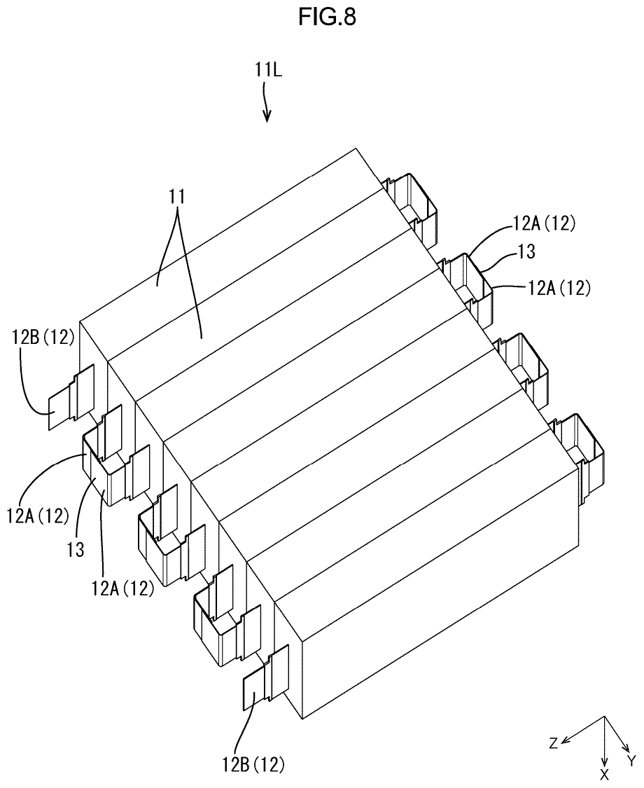

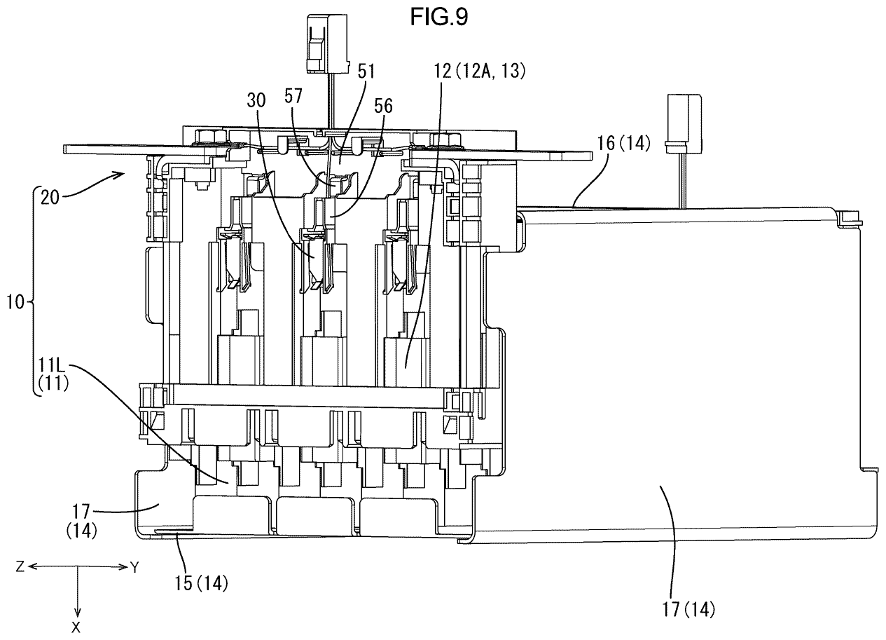

The battery module 10 includes a battery stack member 11L illustrated in FIG. 8 and the wiring modules 20 that are attached to a front side and a rear side of the battery stack member 11L as illustrated in FIG. 9. As illustrated in FIGS. 1 and 9, the battery module 10 of this embodiment further includes a casing 14 that covers the battery stack member 11L from four sides, that are from upper, lower, right, and left sides. The casing 14 includes a bottom portion 15 that is placed on a lower surface side of the battery stack member 11L, a ceiling portion 16 that is placed on an upper surface side of the battery stack member 11L, and a pair of side portions 17 that connect the bottom portion 15 and the ceiling portion 16 on the right and left sides.

### Coupling Direction

As illustrated in FIG. 9, the wiring module 20 of this embodiment is coupled to the battery stack member 11L, which is arranged in the casing 14, in a coupling direction (the direction designated by an arrow X) (details will be described later). In this description, the direction designated by the arrow X is specified as the lower direction and the coupling direction corresponds to the lower direction. However, for example, the battery stack member 11L and the wiring module 20 may be arranged such that the coupling direction corresponds to the front direction or the left direction. The direction corresponding to the direction designated by the arrow X in this description (the width direction of the electrode lead 12) at the time of coupling of the wiring module 20 and the battery stack member 11L may not match the direction corresponding to the direction designated by the arrow X when the battery module 10 is used.

### Laminated Type Battery, Electrode Lead

As illustrated in FIG. 8, the battery stack member 11L includes laminated type batteries 11 (eight laminated type batteries in this embodiment) that are stacked in a right-left direction. The laminated type batteries 11 have a flat shape that is elongated in a front-rear direction and has a small thickness in the right-left direction. The laminated type batteries 11 include power storage elements (not illustrated) therein. The laminated type battery 11 includes a pair of electrode leads 12. The pair of electrode leads 12 are on front and rear sides of the laminated type battery 11, respectively, and protrude from the laminated type battery 11 in opposite directions. The pair of electrode leads 12 have a plate shape and have opposite polarities.

### Connection Portion, Connection Electrode Lead, Plate Thickness Direction, Terminal Width Direction

As illustrated in FIG. 8, the battery stack member 11L includes connection portions 13 where the electrode leads 12 of the adjacent laminated type batteries 11 are electrically connected. The electrode leads 12 are bent leftward or rightward at a right angle and overlapped and connected with welding and thus, the connection portions 13 are formed. A plate thickness direction of the connection portions 13 is defined as the front-rear direction. A direction perpendicular to the plate thickness direction and the coupling direction is defined as a terminal width direction (the right-left direction in this embodiment). Some of the electrode leads 12 are configured as the connection portions 13 and are defined as connection electrode leads 12A.

Since a process of forming the connection portions 13 includes a process of bending the electrode leads 12 and a process of laser welding, tolerances of the connection portions 13 (and the connection electrode leads 12A) with respect to the plate thickness direction are particularly likely to become large. For example, in this embodiment, the tolerance of the connection portion 13 (and the connection electrode lead 12A) with respect to the plate thickness direction is a large value compared to a thickness of the electrode lead 12.

### Correct Position Range

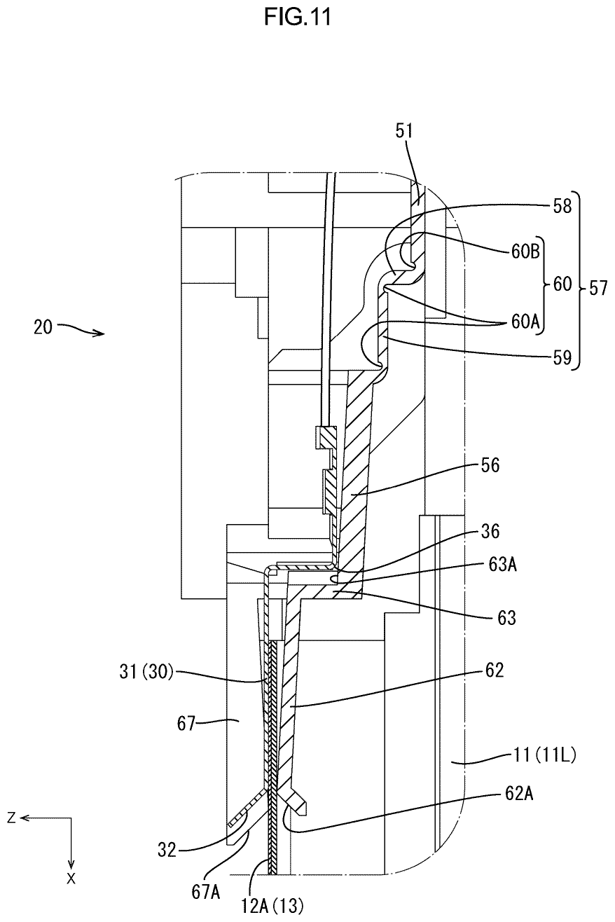

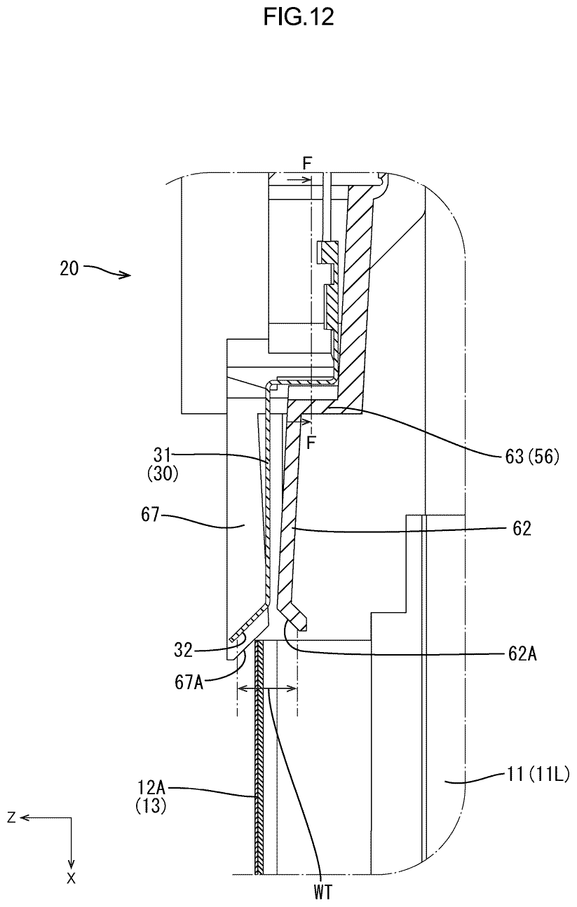

With considering the tolerance of the connection electrode lead 12A with respect to the plate thickness direction, an area where the connection electrode lead 12A is disposed has a certain width in the front-rear direction as illustrated in FIG. 12. In the following, the area where the connection electrode lead 12A is to be disposed with respect to the front-rear direction is referred to as a correct position range WT. In FIGS. 11 to 15 that are referred to in the following description, the connection portion 13 (the connection electrode lead 12A), a terminal 30, a terminal housing portion 56, a hinge portion 57, and other components some of which are illustrated with cross sections, are illustrated and some components in the background such as an end portion electrode lead 12B and a busbar 40 are not illustrated for easy understanding.

As illustrated in FIG. 8, some of the electrode leads 12 other than the connection electrode leads 12A, that are not configured as the connection portions 13, are defined as the end portion electrode leads 12B. The end portion electrode leads 12B are on two end portions of the battery stack member 11L and protrude frontward. The end portion electrode lead 12B is configured as a positive polarity or a negative polarity of the whole battery stack member 11L.

### Wiring Module

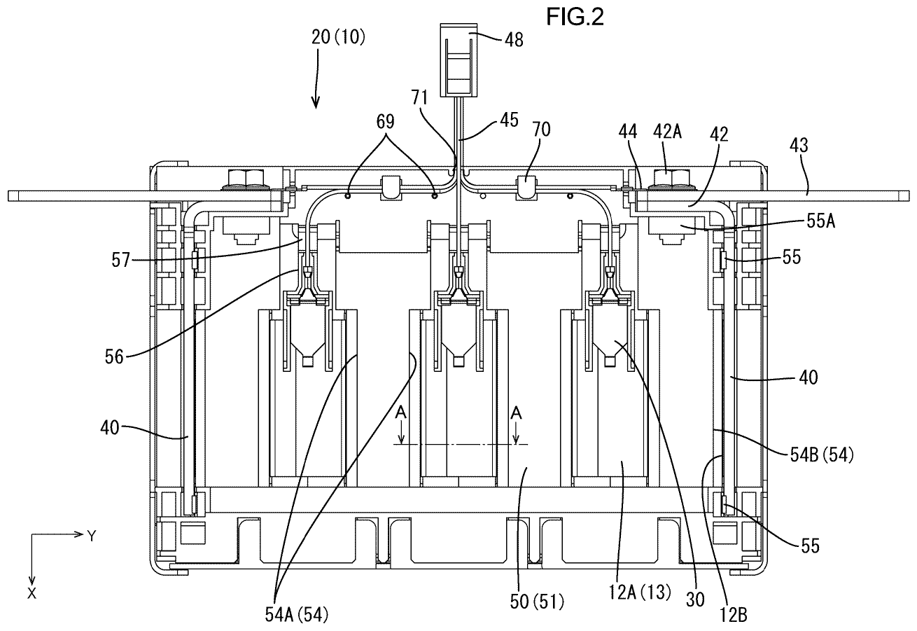

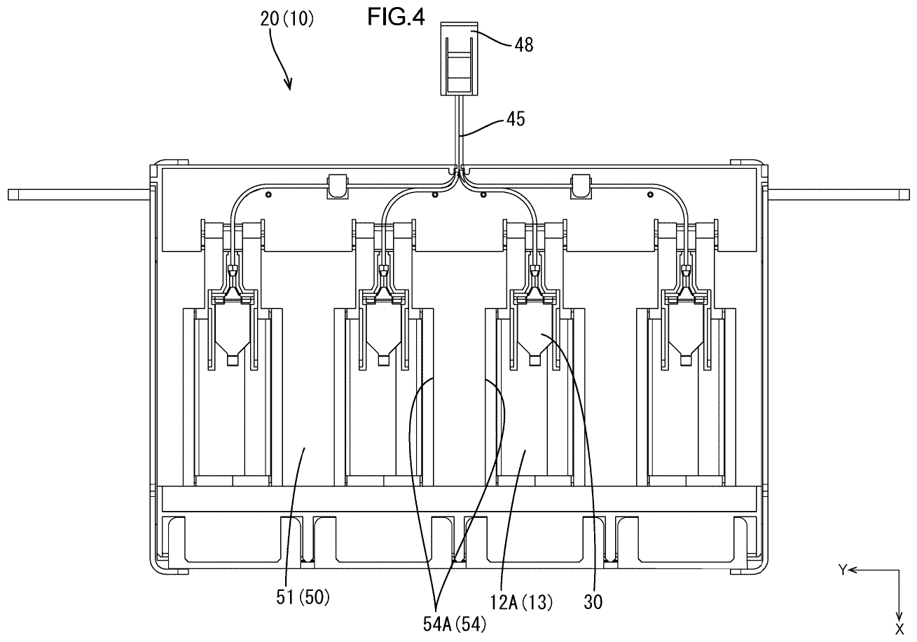

As illustrated in FIG. 2, the wiring module 20 includes terminals 30 that are connected to the connection electrode leads 12A, the busbars 40 that are connected to the end portion electrode leads 12B, electric wires 45 that are connected to the terminals 30 or the busbars 40, and a protector 50 that holds the terminals 30, the busbars 40, and the electric wires 45. In the following, a configuration of the wiring module 20 that is arranged on a front side of the battery stack member 11L will be described in detail. As illustrated in FIG. 4, the wiring module 20 arranged on a rear side of the battery stack member 11L does not include the busbars 40. Besides that, the wiring module 20 on the rear side has a configuration similar to that of the wiring module 20 arranged on the front side of the battery stack member 11L.

### Protector

As illustrated in FIG. 1, the protector 50 is made of synthetic resin having insulating properties and has a plate shape. The protector 50 includes a protector body 51 that is positioned with respect to the casing 14 (and the battery stack member 11L). The detailed configuration of the protector 50 will not be described. The protector body 51 and the casing 14 have protrusions and recessed portions that extend in the coupling direction and are fitted together. According to such a configuration, the wiring module 20 is guided and coupled to the battery stack member 11L.

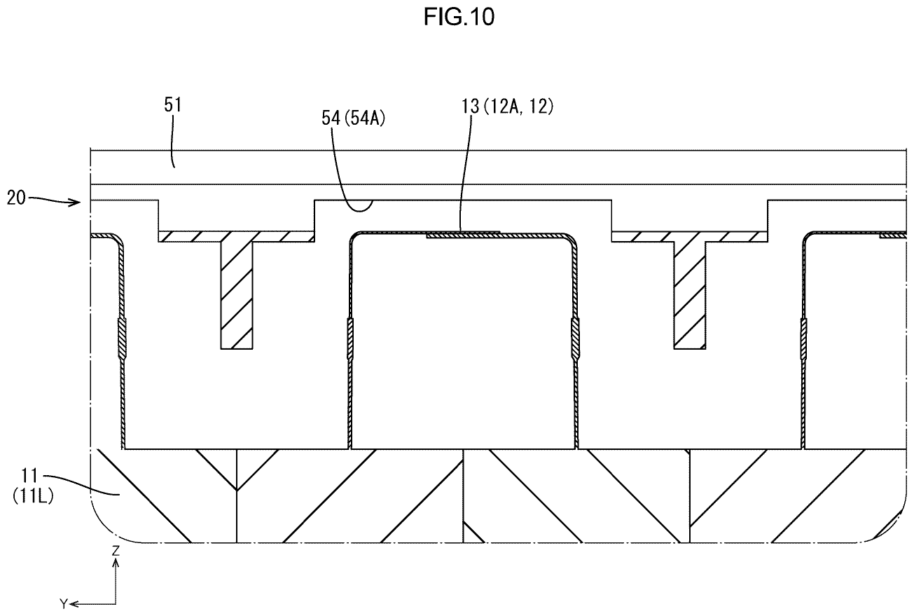

As illustrated in FIG. 2, the protector body 51 includes electrode receiving portions 54 in a middle with respect to the upper-bottom direction. The electrode receiving portions 54 are arranged in the right-left direction and are through in the front-rear direction and have a rectangular shape that is elongated in the upper-bottom direction. The electrode receiving portions 54 include connection electrode receiving portions 54A that receive the connection portions 13 and the connection electrode leads 12A and end portion electrode receiving portions 54B that receive the end portion electrode leads 12B. As illustrated in FIG. 10, the electrode receiving portions 54 also open downward such that the electrode leads 12 do not contact the electrode receiving portions 54 at the time of mounting of the wiring module 20.

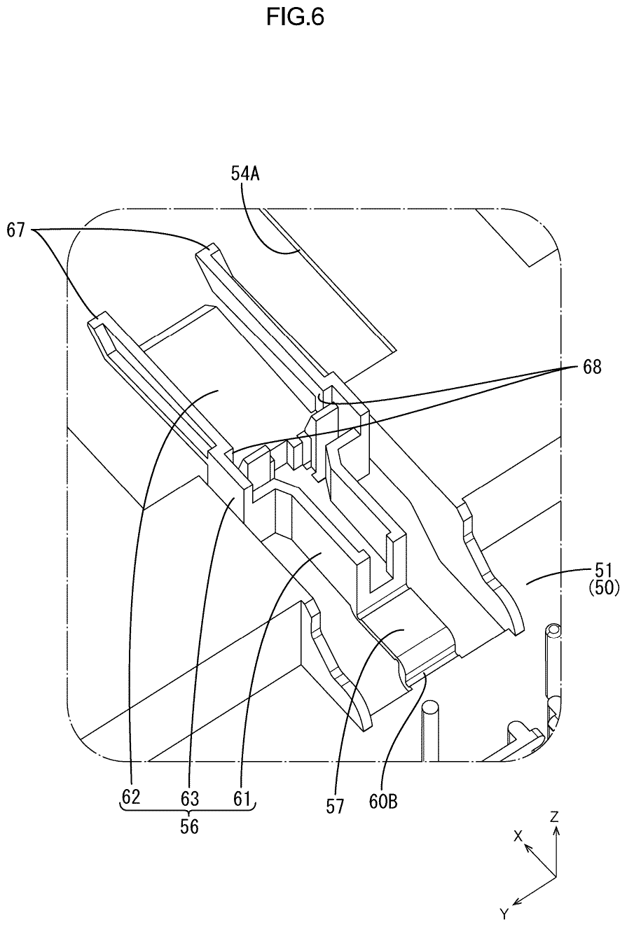

As illustrated in FIG. 2, the end portion electrode receiving portion 54B includes busbar holding portions 55, which hold the busbar 40, on upper and lower portions thereof. A bolt fixing portion 55A for fixing the busbar 40 with a screw is near the upper busbar holding portion 55. As illustrated in FIG. 6, a terminal housing portion 56 is on an upper side section of the connection electrode receiving portion 54A. The terminal 30 is positioned and arranged in the terminal housing portion 56. The terminal housing portion 56 is connected to the protector body 51 via a hinge portion 57.

### Hinge Portion

As illustrated in FIG. 11, the hinge portion 57 includes a protrusion section 58 that protrudes frontward from the protector body 51 and an extending section 59 that extends from the protrusion section 58 toward the back side with respect to the coupling direction (downward). The hinge portion 57 includes reduced thickness portions 60 that are reduced in thickness in the plate thickness direction compared to surrounding portions. The reduced thickness portions 60 are included in a joint portion of the terminal housing portion 56 and the extending section 59, a joint portion of the extending section 59 and the protrusion section 58, and a joint portion of the protrusion section 58 and the protector body 51. The reduced thickness portions 60 are formed in a groove having a U-shape with a side view and extend in the right-left direction. The reduced thickness portions 60 at the joint portion of the terminal housing portion 56 and the extending section 59 and the joint portion of the extending section 59 and the protrusion section 58 are defined as first reduced thickness portions 60A. The reduced thickness portion 60 at the joint portion of the protrusion section 58 and the protector body 51 is defined as a second reduced thickness portion 60B. The first reduced thickness portions 60A are thinner than the second reduced thickness portions 60B.

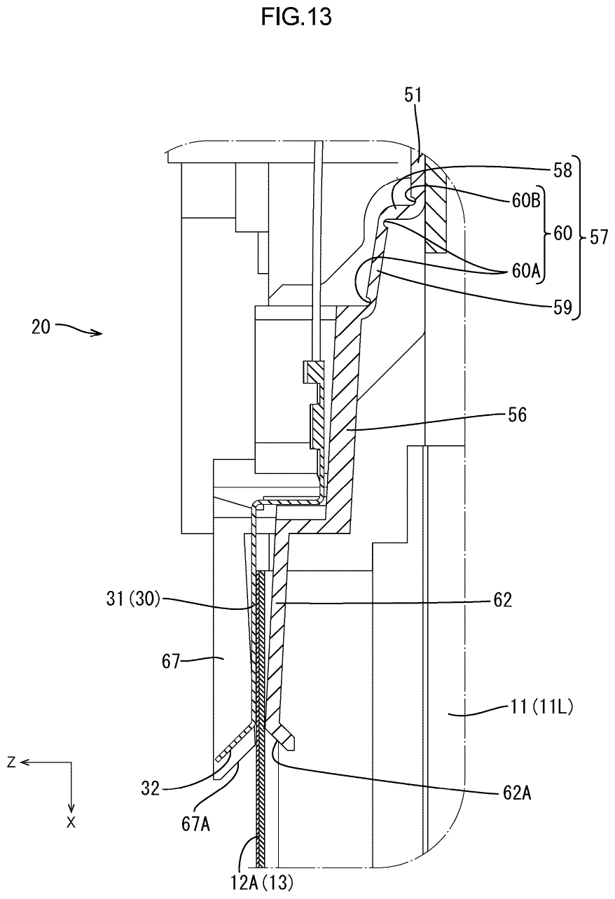

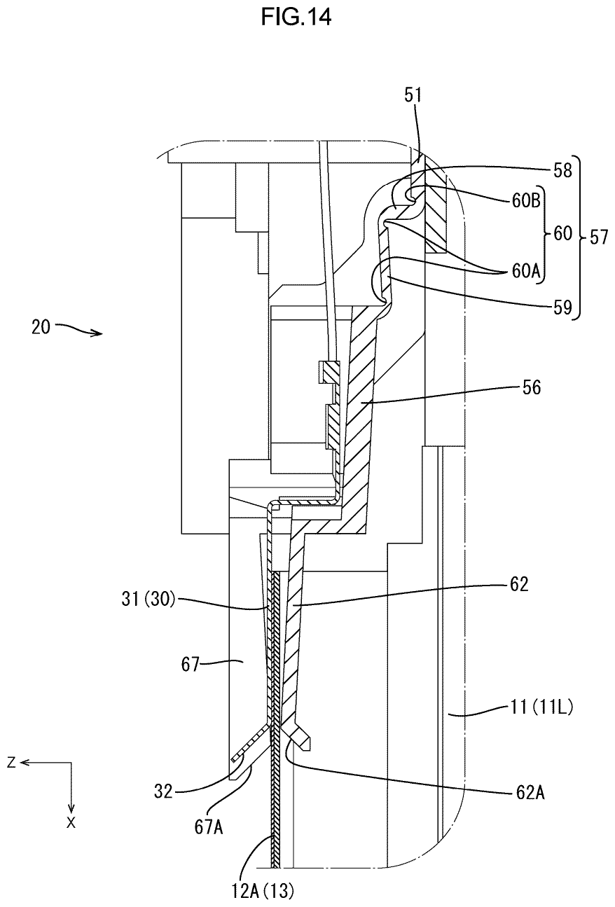

As illustrated in FIGS. 13 and 14, with a force being applied to the terminal housing portion 56, the hinge portion 57 is bent along the reduced thickness portions 60 that function as folding portions and deformed. Namely, with the hinge portion 57 being deformable, the terminal housing portion 56 is movable with respect to the protector body 51. As will be described later, the hinge portion 57 is bent along the first reduced thickness portions 60A, which is particularly thin, and likely to be deformed.

### Terminal Housing Portion

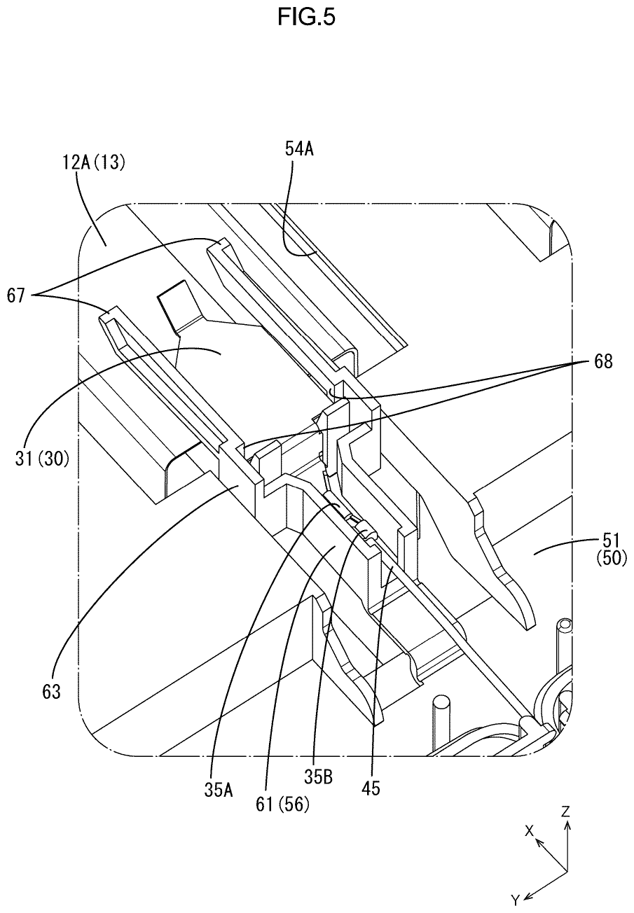

As illustrated in FIG. 6, the terminal housing portion 56 includes a barrel housing recess portion 61 that is connected to the hinge portion 57, an electrode support portion 62 that is on the back side with respect to the coupling direction, and an intermediate frame portion 63 that is disposed between the barrel housing recess portion 61 and the electrode support portion 62. The barrel housing recess portion 61 extends in the coupling direction and is recessed rearward and has a gate shape. As illustrated in FIG. 5, a wire barrel portion 35A and an insulation barrel portion 35B of the terminal 30 and a portion of the electric wire 45 are arranged in the barrel housing recess portion 61.

### Electrode Support Portion

As illustrated in FIG. 11, the electrode support portion 62 is a plate member and is disposed behind an electrode connection portion 31 of the terminal 30. The electrode support portion 62 extends downward from a lower end of a middle of the intermediate frame portion 63 with respect to the right-left direction and is inclined frontward. The electrode support portion 62 includes an electrode support portion side slope surface 62A that is inclined rearward as it extends downward. As illustrated in FIG. 12, when the wiring module 20 is coupled to the battery stack member 11L, the electrode support portion side slope surface 62A is disposed in a rear section of the correct position range WT.

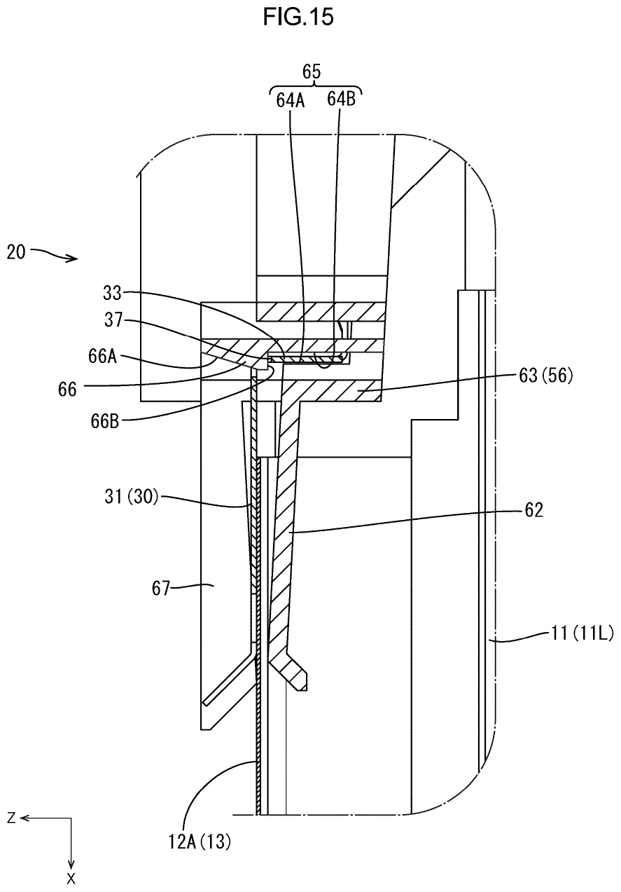

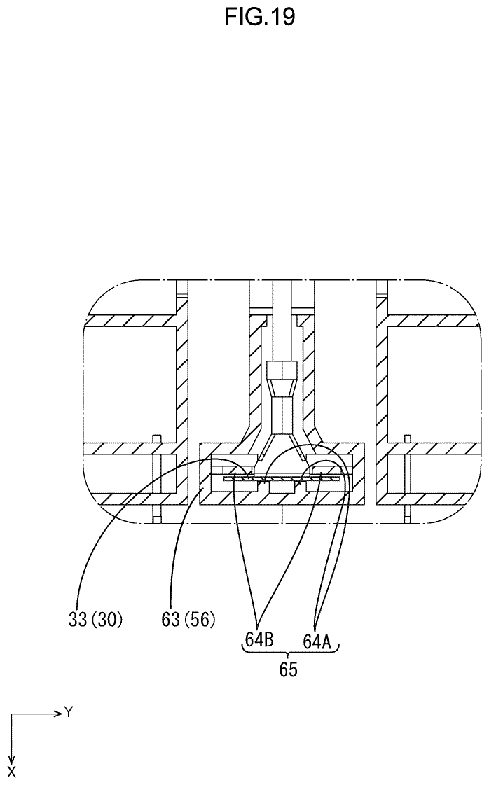

As illustrated in FIGS. 15 and 19, lower contact portions 64A and upper contact portions 64B are inside the intermediate frame portion 63 so as to be spaced from each other in the upper-bottom direction. The lower contact portions 64A are disposed to be contacted with a middle portion of a bent portion 33 of the terminal 30 with respect to the right-left direction from a lower side. The upper contact portions 64B are disposed to be contacted with two end portions of the bent portion 33 with respect to the right-left direction from an upper side. Thus, the lower contact portions 64A and the upper contact portions 64B are configured as a first movement suppress portion 65 that suppress movement of the terminal 30 in the upper-bottom direction.

As illustrated in FIG. 15, the upper contact portion 64B includes a stopper protrusion 66, which protrudes downward, on a front section thereof. The stopper protrusion 66 includes a fitting surface 66A and a front stopper portion 66B. The fitting surface 66A is inclined downward as it extends rearward. The front stopper portion 66B extends vertically with respect to the bent portion 33 and is configured as a rear edge surface of the stopper protrusion 66. By sliding a rear end portion of the bent portion 33 with respect to the fitting surface 66A, the terminal 30 can be arranged in the terminal housing portion 56 easily. With the front stopper portion 66B being contacted with a front end portion of the bent portion 33, the terminal 30 is less likely to move frontward. As illustrated in FIG. 11, the intermediate frame portion 63 includes a rear stopper portion 63A on a rear section thereof. The rear stopper portion 63A is contacted with the rear end portion of the bent portion 33. With the rear stopper portion 63A, the terminal 30 is less likely to move rearward.

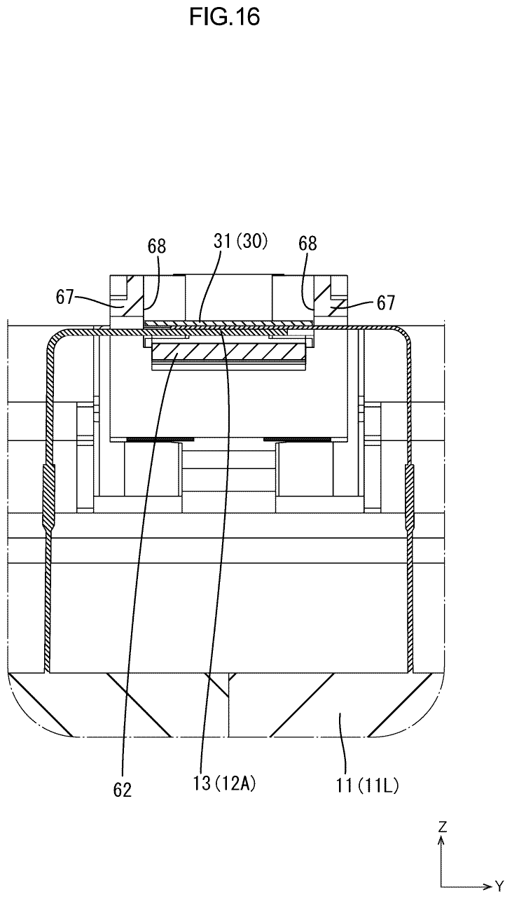

As illustrated in FIG. 6, the intermediate frame portion 63 includes second movement suppress portions 68 having a cutout shape in a lower wall portion thereof. As illustrated in FIGS. 5 and 16, the second movement suppress portions 68 are configured to be contacted with the electrode connection portion 31 of the terminal 30 from the right and left sides to suppress the movement of the terminal 30 in the right-left direction.

### Terminal Protection Arm

As illustrated in FIG. 5, a pair of terminal protection arms 67 extend from lower end portions of right and left side portions of the intermediate frame portion 63. The pair of terminal protection arms 67 are disposed on right and left sides of the electrode connection portion 31. As illustrated in FIG. 11, the terminal protection arms 67 are disposed in front of the connection electrode lead 12A and extend downward further than a slope surface 32. The terminal protection arm 67 includes a terminal protection arm side slope surface 67A that is inclined frontward as it extends downward. As illustrated in FIG. 12, when the wiring module 20 is coupled to the battery stack member 11L, the terminal protection arm side slope surface 67A is disposed in the rear section of the correct position range WT.

### Terminal

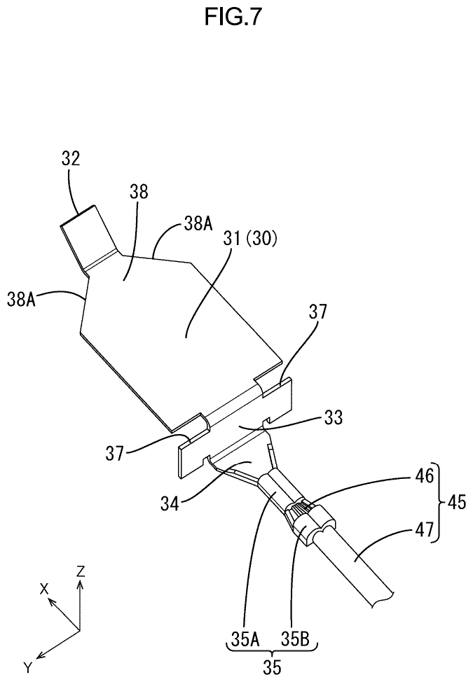

As illustrated in FIG. 7, the terminal 30 is formed by processing an electrically conductive metal plate. The terminal 30 includes the electrode connection portion 31, the slope surface 32 that continuously extends from the electrode connection portion 31 toward the back side with respect to the coupling direction (downward), and the bent portion 33 that extends rearward from the upper end portion of the electrode connection portion 31. A trapezoid portion 38 that becomes narrower as it extends downward is between the electrode connection portion 31 and the slope surface 32. A wire connection portion 35 is connected to a rear end portion of the bent portion 33 via a joint portion 34. The wire connection portion 35 includes the wire barrel portion 35A that is crimped onto a core wire 46 of the electric wire 45 and the insulation barrel portion 35B that is crimped onto an insulating sheath 47 of the electric wire 45.

As illustrated in FIG. 11, the terminal 30 is configured to be connected to the connection portion 13 or a portion of the connection electrode lead 12A of the connection portion 13. Namely, the terminal 30 is not for connecting the adjacent connection electrode leads 12A but for connecting the connection electrode leads 12A that are previously connected (the connection portion 13) and the electric wire 45. Therefore, the dimension of the terminals 30 with respect to the upper-bottom direction can be smaller than the dimension of the connection electrode leads 12A with respect to the upper-bottom direction.

### Electrode Connection Portion

As illustrated in FIG. 12, in the wiring module 20, the electrode connection portion 31 is disposed in front of the electrode support portion 62 with having a space therebetween. The smallest space between the electrode connection portion 31 and the electrode support portion 62 with respect to the front-rear direction is substantially same as the plate thickness of the connection portion 13. As illustrated in FIG. 11, with the wiring module 20 being coupled to the battery stack member 11L, the connection electrode lead 12A is disposed between the electrode connection portion 31 and the electrode support portion 62 with respect to the front-rear direction. The electrode connection portion 31 is electrically connected to the connection electrode lead 12A with laser welding.

### Bent Portion

As illustrated in FIG. 15, the bent portion 33 has a plate shape and is disposed vertically with respect to the connection portion 13. The thickness direction of the bent portion 33 corresponds to the upper-bottom direction. In the wiring module 20, the bent portion 33 is arranged between the lower contact portion 64A and the upper contact portion 64B. As illustrated in FIG. 7, front stop portions 37 having a notch shape are on right and left front edge portions of the bent portion 33. As illustrated in FIG. 15, the front stop portions 37 are disposed to be fitted to the front stopper portions 66B. As illustrated in FIG. 11, a rear edge portion of the bent portion 33 is defined as a rear stop portion 36 and the rear stop portion 36 is disposed to be contacted with the rear stopper portion 63A.

### Slope Surface

As illustrated in FIG. 12, the slope surface 32 is inclined frontward as it extends downward. Namely, the slope surface 32 is farther away from the electrode support portion 62 with respect to the front-rear direction as it extends downward. When the wiring module 20 is coupled to the battery stack member 11L, the slope surface 32 is disposed in a front section of the correct position range WT.

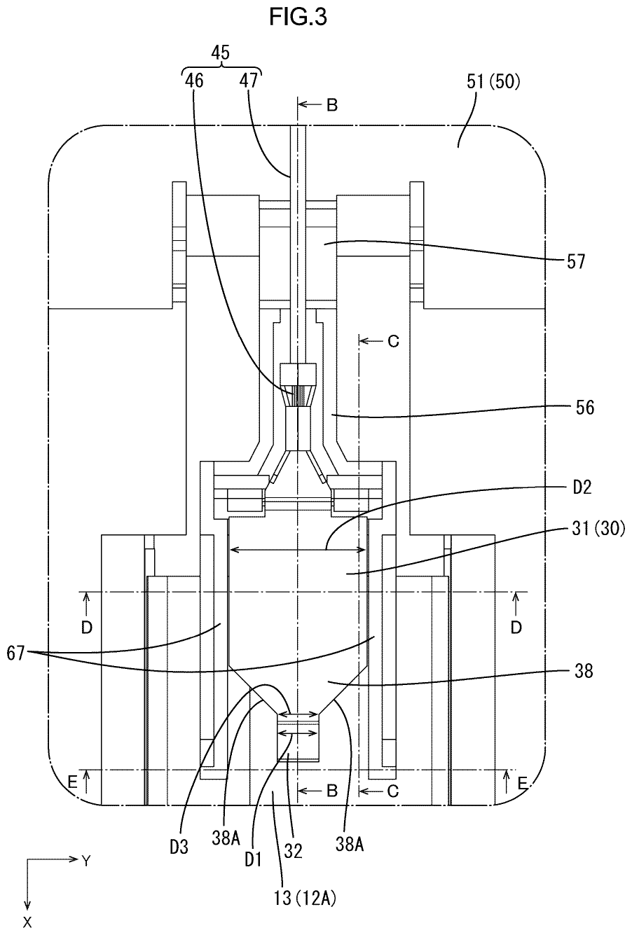

As illustrated in FIG. 3, the slope surface 32 is continuous from a middle of a lower end of the electrode connection portion 31 with respect to the right-left direction. A dimension D1 of the slope surface 32 extending in the right-left direction is smaller than a dimension D2 of the electrode connection portion 31 extending in the right-left direction. Therefore, when the electrode connection portion 31 and the connection electrode lead 12A are closely contacted with each other with a zig, which is not illustrated, and processed with laser welding, the middle section of the electrode connection portion 31 can be welded with the right and left edge portions of the electrode connection portion 31 being pressed with a zig and the slope surface 32 being not pressed.

As illustrated in FIG. 3, the trapezoid portion 38 is between the electrode connection portion 31 and the slope surface 32 and is on the same plane as the electrode connection portion 31. The trapezoid portion 38 has a dimension extending in the right-left direction that decreases as it extends downward. The trapezoid portion 38 has a symmetrical shape with respect to the right-left direction. A lower end portion of the trapezoid portion 38 is in a position corresponding to a middle of the electrode connection portion 31 with respect to the right-left direction and continuous to the slope surface 32. The lower end portion of the trapezoid portion 38 has a dimension D3 extending in the right-left direction and the dimension D3 is same as the dimension D1 of the slope surface 32 extending in the right-left direction. The trapezoid portion 38 has edge portions 38A that continuously connect the right and left edge portions of the slope surface 32 and the right and left edge portions of the electrode connection portion 31, respectively.

### Busbar

The busbars 40 have a plate shape and are made by processing a metal plate having electrically conductive properties. As illustrated in FIG. 2, the busbars 40 are held in the busbar holding portions 55 of the protector 50 such that a plate thickness direction of the busbars 40 corresponds to the right-left direction. As illustrated in FIG. 1, a middle section of the busbar 40 is configured as a busbar body portion 41 that is connected to the end portion electrode lead 12B. When the busbar body portion 41 and the end portion electrode lead 12B are connected, the end portion electrode lead 12B may be bent as appropriate so as to be contacted with the busbar body portion 41. The busbar 40 includes an upper portion that is configured as a busbar side connection portion 42 that is bent leftward or rightward with respect to the busbar body portion 41.

As illustrated in FIG. 2, the busbar side connection portion 42 has a through hole (not illustrated) through which a bolt 42A is inserted and thus and the busbar side connection portion 42 is fixed to the bolt fixing portion 55A with the bolt. As illustrated in FIG. 1, an external connection terminal 43 and a relay terminal 44 are disposed on the busbar side connection portion 42 and fixed together with the busbar side connection portion 42 with the bolt. Accordingly, the busbar side connection portion 42 is electrically connected to the external connection terminal 43 and the relay terminal 44. The external connection terminal 43 is an electrically conductive metal plate that is disposed to protrude leftward or rightward with respect to the battery module 10. The external connection terminal 43 is used for connecting the battery module 10 and an external device, which is not illustrated. The relay terminal 44 is an electrically conductive metal plate and for connecting the busbar side connection portion 42 and the electric wire 45. The relay terminal 44 is connected to the electric wire 45 similar to the terminal 30.

### Electric Wire

As illustrated in FIG. 3, the electric wire 45 includes the core wire 46 (not illustrated in the drawings other than FIGS. 3 and 7) and the insulating sheath 47 that covers the core wire 46. As illustrated in FIG. 2, one end of each electric wire 45 is connected to the terminal 30 or the relay terminal 44 and other ends of the electric wires 45 are collectively connected to the connector 48. The electric wires 45 are routed in predefined sections of the protector 50 with routing protrusions 69, electric wire holders 70, and a routing groove 71 that are on the protector 50.

The connector 48 is made of synthetic resin having insulating properties and has a block shape as illustrated in FIG. 1. The connector 48 includes a female terminal, which is not illustrated, therein. The connector 48 is to be fitted to a target connector including a male terminal. The target connector is connected to an external ECU (electronic control unit) via an electric wire, which is not illustrated. The ECU has a known configuration including a microcomputer and components and has a function of detecting a voltage, a current, and a temperature of each laminated type battery 11 and has a function of controlling charging and discharging of each laminated type battery 11.

The present embodiment has the above-described configuration and operations of the terminal 30 at the time of coupling of the wiring module 20 and the battery stack member 11L will be described.

First, with the connection electrode lead 12A being disposed such that right and left portions of the connection electrode lead 12A are in the same position with respect to the front-rear direction, the operations are as follows. As illustrated in FIG. 12, with the connection electrode lead 12A being disposed in the front section of the correct position range WT, the upper end portion of the connection electrode lead 12A comes in contact with the terminal protection arm side slope surface 67A. When the connection electrode lead 12A comes in contact with the terminal protection arm side slope surface 67A, the terminal housing portion 56 receives a force toward the front side (upward) in the coupling direction. Since the terminal housing portion 56 is movable with respect to the protector body 51 with the hinge portion 57, the hinge portion 57 is bent mainly at the second reduced thickness portion 60B to absorb the upward force applied to the terminal housing portion 56 (refer to FIG. 6).

As the wiring module 20 moves downward, the upper end portion of the connection electrode lead 12A slides along the terminal protection arm side slope surface 67A and this moves the terminal housing portion 56 frontward. As illustrated in FIG. 13, with the hinge portion 57 being bent at the first reduced thickness portions 60A, the terminal housing portion 56 moves frontward corresponding to the position of the connection electrode lead 12A in the front-rear direction. The connection electrode lead 12A slides along the slope surface 32 and finally the connection electrode lead 12A (the connection portion 13) is disposed between the electrode connection portion 31 and the electrode support portion 62.

In this embodiment, since the terminal protection arm side slope surface 67A is below the slope surface 32 of the terminal 30, the connection electrode lead 12A slides along the terminal protection arm side slope surface 67A prior to the slope surface 32. Accordingly, the sliding of the connection electrode lead 12A and the slope surface 32 can be possibly reduced and the connection electrode lead 12A is less likely to hit the slope surface 32 without sliding.

With the connection electrode lead 12A being disposed in the rear section of the correct position range WT, the upper end portion of the connection electrode lead 12A comes in contact with the electrode support portion side slope surface 62A (refer to FIG. 12). As the wiring module 20 moves downward, the upper end portion of the connection electrode lead 12A slides along the electrode support portion side slope surface 62A and this moves the terminal housing portion 56 rearward. As illustrated in FIG. 14, with the hinge portion 57 being bent at the first reduced thickness portions 60A, the terminal housing portion 56 moves rearward corresponding to the position of the connection electrode lead 12A in the front-rear direction.

With the connection electrode lead 12A being disposed just between the terminal protection arm side slope surface 67A and the electrode support portion side slope surface 62A, the connection electrode lead 12A (the connection portion 13) is disposed between the electrode connection portion 31 and the electrode support portion 62 (refer to FIG. 11). That is, the hinge portion 57 is not deformed and the position of the terminal housing portion 56 does not change from the position before the coupling of the connection electrode lead 12A.

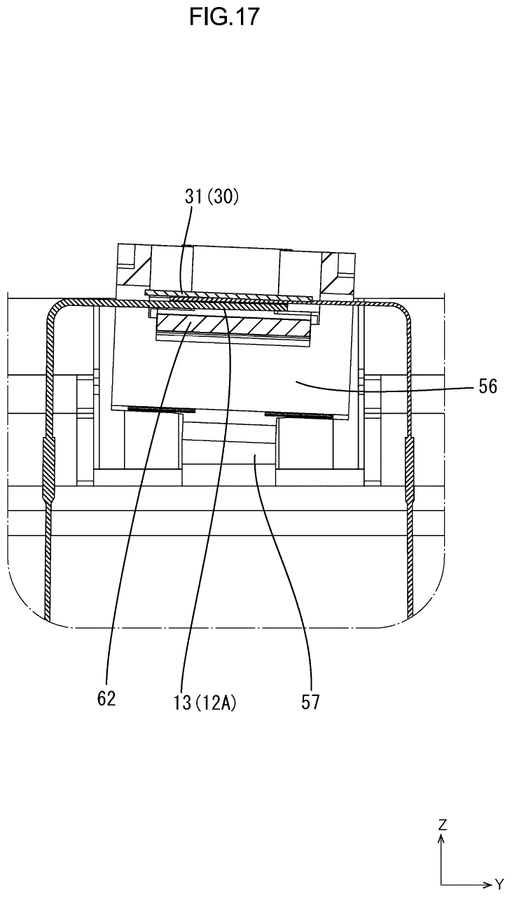

Next, with the connection electrode lead 12A being disposed such the right and left portions of the connection electrode lead 12A being in different positions with respect to the front-rear direction, for example, as illustrated in FIG. 17, with the connection electrode lead 12A being inclined rearward as it extends leftward, the operations are as follows. In such a configuration, since the right portion of the connection electrode lead 12A is disposed in the front section of the correct position range WT, the right portion of the terminal housing portion 56 moves frontward by the deformation of the hinge portion 57 similarly to FIG. 13. On the other hand, since the left portion of the connection electrode lead 12A is disposed in the rear section of the correct position range WT, the left portion of the terminal housing portion 56 moves rearward by the deformation of the hinge portion 57 similarly to FIG. 14. As a result, with the deformation direction of the hinge portion 57 being different with respect to the right-left direction, the terminal housing portion 56 can move so as to be rotated around a shaft extending in the upper-bottom direction (the vertical direction with respect to the sheet) as illustrated in FIG. 17. Thus, the connection electrode lead 12A (the connection portion 13) can be disposed between the electrode connection portion 31 and the electrode support portion 62.

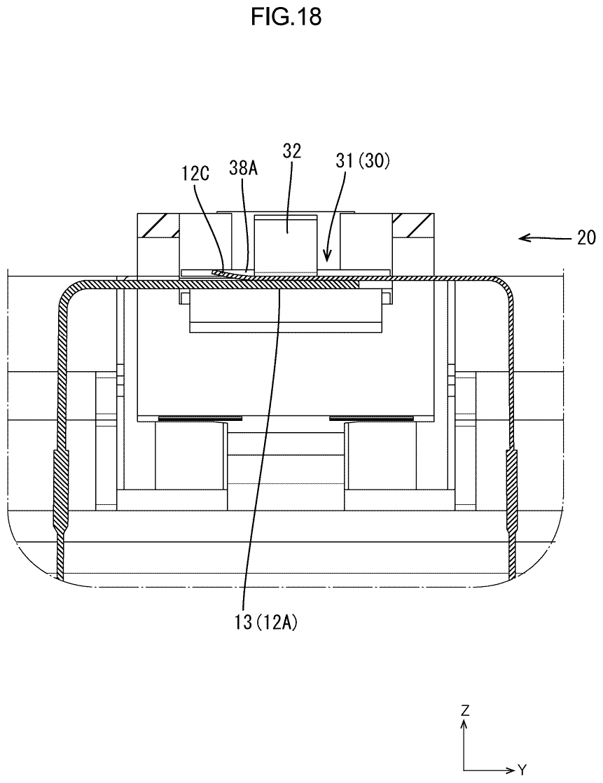

Lastly, as illustrated in FIG. 18, with the connection electrode lead 12A disposed in the position so as not to be contacted with the slope surface 32 having a warped portion 12C warped toward the terminal 30 (frontward), the operations are as follows. FIG. 18 illustrates the wiring module 20 that is being coupled to the battery stack member 11L and before the upper end portion of the connection electrode lead 12A being contacted with the terminal 30. In this embodiment, as illustrated in FIG. 3, the trapezoid portion 38 is between the slope surface 32 and the electrode connection portion 31 so as to continuously extend in the right-left direction. Therefore, when the terminal 30 comes in contact with the connection electrode lead 12A, the warped portion 12C of the connection electrode lead 12A slides along the edge portion 38A of the trapezoid portion 38. Thus, the connection electrode lead 12A is less likely to hit the electrode connection portion 31.

### Operations and Effects of First Embodiment

According to the first embodiment, operations and effects described below are obtained.

The wiring module 20 according to the first embodiment is to be coupled to the battery stack member 11L that includes the laminated type batteries 11 that are stacked. The laminated type batteries 11 include the electrode leads 12. The electrode leads 12 are overlapped and connected to be configured as the connection portion 13. The wiring module 20 is to be coupled to the battery stack member 11L that includes the connection portions 13 in the coupling direction that is perpendicular to the plate thickness direction of the connection portion 13. The wiring module 20 includes the terminals 30, the electric wires 45 connected to the terminals 30, and the protector 50 that holds the terminals 30 and the electric wires 45. Some of the electrode leads 12 that are configured as the connection portions 13 are defined as the connection electrode leads 12A. The terminals 30 include the electrode connection portions 31 that are electrically connected to the connection portions 13, respectively. The protector 50 includes the protector body 51 and the terminal housing portions 56 in which the terminals 30 are arranged with being positioned, respectively. The terminal housing portions 56 are movably connected to the protector body 51 via the hinge portion 57.

With the configuration described above, when the wiring module 20 is coupled to the battery stack member 11L, the electrode connection portion 31 is likely to move along the connection electrode lead 12A. Therefore, the electrical connection error is less likely to occur between the connection electrode lead 12A and the terminal 30.

In the first embodiment, the hinge portion 57 includes the reduced thickness portions 60.

With the configuration described above, the hinge portion 57 is deformed easily and the terminal housing portion 56 can move easily with respect to the protector body 51.

In the first embodiment, the terminal 30 includes the slope surface 32 that is continuous to the electrode connection portion 31 and is inclined toward one side with respect to the plate thickness direction as it extends toward the back side with respect to the coupling direction. The slope surface 32 is disposed in at least a section of the range WT in which the connection electrode lead 12A is to be disposed with respect to the plate thickness direction.

With the configuration described above, when the wiring module 20 is coupled to the battery stack member 11L, with the slope surface 32 sliding along the end portion of the connection electrode lead 12A on the front side with respect to the coupling direction, the terminal 30 moves in the plate thickness direction with respect to the connection electrode lead 12A. Therefore, the electrode connection portion 31 easily moves along the connection electrode lead 12A.

In the first embodiment, the terminal housing portion 56 includes the electrode support portion 62 that is disposed opposite the electrode connection portion 31 with respect to the plate thickness direction. The slope surface 32 is inclined so as to be away from the electrode support portion 62 as it extends toward the back side in the coupling direction. The connection electrode lead 12A is disposed between the electrode connection portion 31 and the electrode support portion 62 with respect to the plate thickness direction.

With the configuration described above, when the wiring module 20 is coupled to the battery stack member 11L, the connection electrode lead 12A is disposed between the electrode connection portion 31 and the electrode support portion 62 and therefore, the electrode connection portion 31 easily moves along the connection electrode lead 12A.

In the first embodiment, the electrode support portion 62 includes the electrode support portion side slope surface 62A at the end portion on the back side with respect to the coupling direction. The electrode support portion side slope surface 62A is inclined toward other side with respect to the plate thickness direction as it extends toward the back side with respect to the coupling direction. The electrode support portion side slope surface 62A is disposed in at least a section of the range WT in which the connection electrode lead 12A is to be disposed with respect to the plate thickness direction.

With the configuration described above, when the wiring module 20 is coupled to the battery stack member 11L, with the electrode support portion side slope surface 62A sliding along the end portion of the connection electrode lead 12A on the front side with respect to the coupling direction, the terminal housing portion 56 moves in the plate thickness direction with respect to the connection electrode lead 12A. Therefore, the connection electrode lead 12A is easily disposed between the electrode connection portion 31 and the electrode support portion 62.

In the first embodiment, the direction perpendicular to the plate thickness direction and the coupling direction is defined as the terminal width direction. The terminal housing portion 56 includes a pair of terminal protection arms 67 on the two side portions of the electrode connection portion 31 with respect to the terminal width direction. The terminal protection arms 67 extend toward the back side with respect to the coupling direction further than the slope surface 32. The pair of terminal protection arms 67 are on the one side with respect to the connection electrode lead 12A in the plate thickness direction.

With the configuration described above, the terminal 30 is protected by the terminal protection arms 67.

In the first embodiment, the terminal protection arms 67 include the terminal protection arm side slope surfaces 67A on the end portions on the back side with respect to the coupling direction. The terminal protection arm side slope surfaces 67A are inclined toward the one side with respect to the plate thickness direction as they extend toward the back side with respect to the coupling direction. The terminal protection arm side slope surface 67A is disposed in at least a section of the range WT in which the connection electrode lead 12A is to be disposed with respect to the plate thickness direction.

With the configuration described above, when the wiring module 20 is coupled to the battery stack member 11L, with the electrode support portion side slope surface 62A sliding along the end portion of the connection electrode lead 12A on the front side with respect to the coupling direction, the terminal housing portion 56 moves in the plate thickness direction with respect to the connection electrode lead 12A. Therefore, the connection electrode lead 12A is easily disposed between the electrode connection portion 31 and the electrode support portion 62.

### Second Embodiment

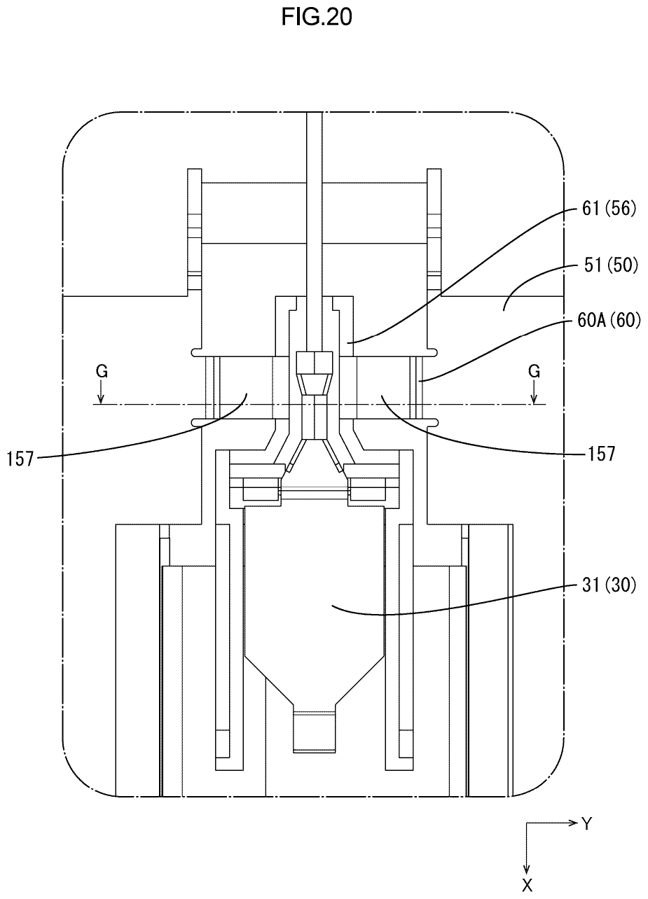

A second embodiment of the present disclosure will be described with reference to FIGS. 20 to 22. A wiring module 120 according to the second embodiment has a configuration same as that of the wiring module 20 of the first embodiment except for a hinge portion 157 that connects the terminal housing portion 56 and the protector body 51. In the following description, the components having the same configuration as those of the first embodiment are indicated by the reference signs of the first embodiment and the components having the same configurations as those of the first embodiment and operations and effects same as those of the first embodiment will not be described.

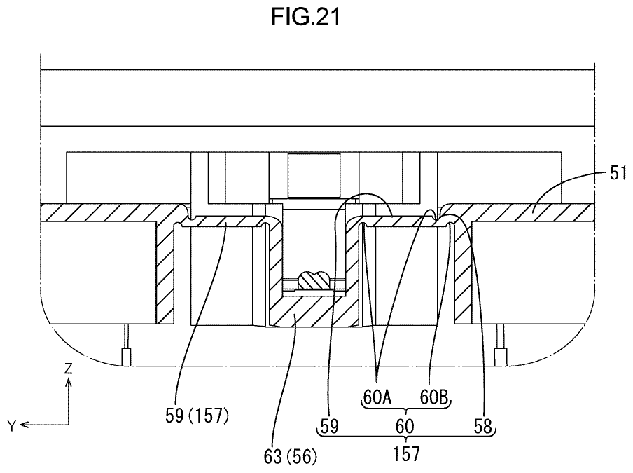

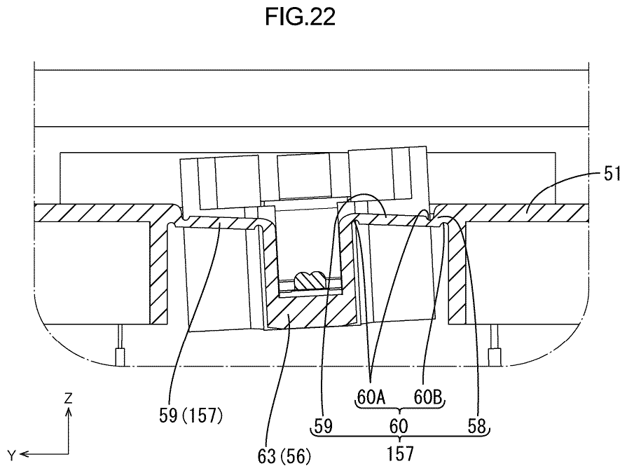

As illustrated in FIG. 20, the second embodiment includes two hinge portions 157 for each terminal housing portion 56. The hinge portions 157 connect the right and left side walls of the barrel housing recess portion 61 and the protector body 51. As illustrated in FIGS. 21 and 22, the hinge portions 157 have a configuration similar to that of the hinge portion 57 of the first embodiment. With the hinge portions 157 being mainly bent along the first reduced thickness portions 60A, the terminal housing portion 56 moves in the front-rear direction.

With the hinge portions 157 being on the right and left sides of the terminal housing portion 56, the terminal housing portion 56 easily moves particularly around an axis extending in the upper-bottom direction. For example, with the connection electrode lead 12A being inclined rearward as it extends leftward (refer to FIG. 17), the hinge portions 157 are deformed such that the extending section 59 of the right hinge portion 157 is inclined frontward and the extending section 59 of the left hinge portion 157 is inclined rearward as illustrated in FIG. 22. Thus, the terminal housing portion 56 is moved to be rotated in a counterclockwise direction seen from the above.

As illustrated in FIG. 20, with the reduced thickness portions 60 of the hinge portions 157 extending in the upper-bottom direction, the hinge portions 157 are less likely to be deformed in the upper-bottom direction compared to the hinge portion 57 of the first embodiment. As previously described, with the multiple hinge portions 157 being provided for the terminal housing portion 56, the direction in which the terminal housing portion 56 is likely to be moved can be adjusted.

### Operations and Effects of Second Embodiment

According to the second embodiment, operations and effects described below are obtained.

The second embodiment includes multiple hinge portions 157 for one terminal housing portion 56.

With such a configuration, the movement of the terminal housing portion 56 with respect to the protector body 51 can be controlled easily.

### Other Embodiments

(1) In the above embodiments, the two electrode leads 12 are connected and configured as the connection portion 13 and the laminated type batteries 11 are connected in series; however, the configuration is not limited to the above one. Three or more electrode leads may be connected and configured as a connection portion and the laminated type batteries may be connected in parallel.

(2) In the above embodiments, the terminal housing portion 56 includes the terminal protection arms 67; however, the terminal housing portion 56 does not necessarily have such a configuration and the terminal protection arms 67 may not be included.

(3) The first embodiment includes one hinge portion 57 for one terminal housing portion 56 and the second embodiment includes two hinge portions 157 for one terminal housing portion 56; however, the configuration is not limited thereto and three or more hinge portions may be provided for one terminal housing portion. The positions of the hinge portions with respect to the terminal housing portion may be altered as appropriate.

(4) In the above embodiments, the trapezoid portion 38 is between the electrode connection portion 31 and the slope surface 32; however, it is not necessarily limited thereto and the trapezoid portion may not be included.

### EXPLANATION OF SYMBOLS

10: Battery module
11: Laminated type battery
11L: Battery stuck member
12: Electrode lead
12A: Connection electrode lead
12B: End portion electrode lead
12C: Warped portion
13: Connection portion
14: Casing
15: Bottom portion
16: Ceiling portion
17: Side portion
20, 120: Wiring module
30: Terminal
31: Electrode connection portion
32: Slope surface
33: Bent portion
34: Joint portion
35: Wire connection portion
35A: Wire barrel portion
35B: Insulation barrel portion
36: Rear stop portion
37: Front stop portion
38: Trapezoid portion
38A: Edge portion
40: Busbar
41: Busbar body portion
42: Busbar side connection portion
42A: Bolt
43: External connection terminal
44: Relay terminal
45: Electric wire
46: Core wire
47: Insulating sheath
48: Connector
50: Protector
51: Protector body
54: Electrode receiving portion
54A: Connection electrode receiving portion
54B: End portion electrode receiving portion
55: Busbar holding portion
55A: Bolt fixing portion
56: Terminal housing portion
57, 157: Hinge portion
58: Protrusion section
59: Extending section
60: Reduced thickness portion
60A: First reduced thickness portion
60B: Second reduced thickness portion
61: Barrel housing recess portion
62: Electrode support portion
62A: Electrode support portion side slope surface
63: Intermediate frame portion
63A: Rear stopper portion
64A: Lower contact portion
64B: Upper contact portion
65: First movement suppress portion
66: Stopper protrusion
66A: Fitting surface
66B: Front stopper portion
67: Terminal protection arm
67A: Terminal protection arm side slope surface
68: Second movement suppress portion
69: Routing protrusions
70: Electric wire holder
71: Routing groove
D1: Dimension of the slope surface extending in the terminal width direction
D2: Dimension H the electrode connection portion extending in the terminal width direction
D3: Dimension of an end portion of the trapezoid portion on the back side with respect to the coupling direction extending in the terminal width direction
WT: Range where the connection electrode lead is to be disposed with respect to the plate thickness direction (correct position range)

1. A wiring module to be coupled to a battery stack member that includes laminated type batteries having electrode leads being stacked, the electrode leads of the laminated type batteries being overlapped and connected and configured as connection portions, the wiring module being to be coupled to the battery stack member including the connection portions in a coupling direction that is perpendicular to a plate thickness direction of the connection portions, the wiring module comprising:
terminals;
electric wires connected to the terminals; and
a protector holding the terminals and the electric wires, wherein
the electrode leads include connection electrode leads that are configured as the connection portions,
the terminals include electrode connection portions that are electrically connected to the connection electrode leads,
the protector includes a protector body and terminal housing portions in which the terminals are disposed with being positioned, and
each of the terminal housing portions is connected movably to the protector body via a hinge portion.

2. The wiring module according to claim 1, wherein the hinge portion includes reduced thickness portions.

3. The wiring module according to claim 1, wherein the hinge portion includes hinge portions and the hinge portions are provided for each of the terminal housing portions.

4. The wiring module according to claim 1, wherein
the terminals include slope surfaces that are continuous to the electrode connection portions (31) and inclined toward one side with respect to the plate thickness direction as the slope surfaces extend toward a back side with respect to the coupling direction, and
each of the slope surfaces is disposed in at least a section of a range in which a corresponding one of the connection electrode leads is to be disposed with respect to the plate thickness direction.

5. The wiring module according to claim 4, wherein
the terminal housing portions include electrode support portions that are disposed opposite the electrode connection portions with respect to the plate thickness direction,
the slope surfaces are inclined so as to be away from the electrode support portions as the slope surfaces extend toward the back side with respect to the coupling direction, and
the connection electrode leads are disposed between the electrode connection portions and the electrode support portions, respectively, with respect to the plate thickness direction.

6. The wiring module according to claim 5, wherein
the electrode support portions include electrode support portion side slope surfaces at end portions on the back side with respect to the coupling direction and the electrode support portion side slope surfaces are inclined toward another side with respect to the plate thickness direction as the electrode support portion side slope surfaces extend toward the back side with respect to the coupling direction, and
each of the electrode support portion side slope surfaces is disposed in at least a section of the range in which corresponding one of the connection electrode leads is to be disposed with respect to the plate thickness direction.

7. The wiring module according to claim 6, wherein
a direction perpendicular to the plate thickness direction and the coupling direction is defined as a terminal width direction,
each of the terminal housing portions includes a pair of terminal protection arms on two side portions of each of the electrode connection portions and the pair of terminal protection arms extend toward the back side with respect to the coupling direction further than the slope surfaces, and
the pair of terminal protection arms are on the one side with respect to the connection electrode leads in the plate thickness direction.

8. The wiring module according to claim 7, wherein
the terminal protection arms include terminal protection arm side slope surfaces on end portions on the back side with respect to the coupling direction and the terminal protection arm side slope surfaces are inclined toward the one side with respect to the plate thickness direction as the terminal protection arm side slope surfaces extend toward the back side with respect to the coupling direction, and
each of the terminal protection arm side slope surfaces is disposed in at least a section of the range in which corresponding one of the connection electrode leads is to be disposed with respect to the plate thickness direction.
